(19) United States
(12) Patent Application Publication
(10) Pub. No.: US 2011/0229062 A1
(43) Pub. Date: Sep. 22, 2011

(54) PIPING BAGS FOR FOODS

(75) Inventors: Helmut Sulger, Waiblingen (DE); Claudia Knecht, Beuren (DE)

(73) Assignee: THERMOHAUSER GMBH, Uhingen (DE)

(21) Appl. No.: 12/894,728

(22) Filed: Sep. 30, 2010

(30) Foreign Application Priority Data
Mar. 17, 2010 (DE) 20 2010 004 117.1

(51) Int. Cl. B65D 30/08; B65D 30/04; B29D 22/00; B32B 27/18

(52) U.S. Cl. 383/116; 383/117; 442/123

(57) ABSTRACT

A piping bag for applying pasty or creamy foods includes an essentially frustoconical bag section including at least one antimicrobial active ingredient.

### RELATED APPLICATION

This application claims priority of German utility model No. 20 2010 004 117.1, the subject matter of which is incorporated herein by reference.

### TECHNICAL FIELD

This disclosure relates to a piping bag for applying foods, which are preferably pasty or creamy foods such as cream, creamy desserts and the like. The disclosure also relates to a plastic-coated fabric for use in the food industry and food sector, in particular for producing the piping bags.

### BACKGROUND

Piping bags, which are also referred to as icing bags or decorating bags, are devices used primarily in kitchens, bakeries and cake shops. They are used for applying foods with a pasty or creamy consistency. This application often serves decorative purposes. However, special foods such as Viennese whirls are also produced using such piping bags.

Examples of foods applied with the help of piping bags are cream/whipped cream, creamy desserts, soft butter, mayonnaise and others.

From the point of view of structure, a piping bag is a pointed bag which consists of a water-resistant material, preferably fabric, e.g., of coated cotton. At the lower pointed end, a so-called “piping nozzle” is or will be attached so that differently sized and differently shaped openings can be provided.

Although there are disposable piping bags, generally made of plastic, which are thrown away after a single use, piping bags intended to be used more than once or many times are used widely. Accordingly, these piping bags have to be cleaned after each use. This cleaning should be extremely thorough since such piping bags are after all intended for processing foods that are particularly readily perishable made from eggs, cream or milk.

However, dirty piping bags can actually be cleaned only by briefly boiling in water or under running hot water. Using detergents is not advisable in this connection since these detergents settle on the surfaces of the piping bag and, in this way, are later able to pass into the foods processed using the piping bag.

Accordingly, it could be helpful to provide piping bags and/or a corresponding materials, in particular for producing piping bags, which reduce hygiene requirements and facilitate the cleaning thereof.

### SUMMARY

We provide a piping bag for applying pasty or creamy foods including an essentially frustoconical bag section including at least one antimicrobial active ingredient.

We also provide fabric for use with pasty or creamy foods including a base cloth and a plastic coating on the base cloth including at least one antimicrobial active ingredient.

### DETAILED DESCRIPTION

It will be appreciated that the following description is intended to refer to specific representative examples of structure and is not intended to define or limit the disclosure, other than in the appended claims.

Our piping bags are characterized in that a bag section comprises at least one antimicrobial active ingredient. The piping bags comprise an essentially frustoconical bag section which can accommodate the corresponding foods.

The term “antimicrobial active ingredient” is intended to encompass all materials/substances which kill microorganisms or suppress the proliferation or growth thereof. The term “microorganism” is intended to be understood in a comprehensive, non-limiting way, i.e., include, for example, bacteria, fungi, algae, protozoa and viruses.

In principle, all types of antimicrobial active ingredients can be used which are suitable for use in connection with foods, in particular pasty or creamy foods. However, it is preferred if the antimicrobial active ingredient is metal atoms or in particular metal ions. Accordingly, the antimicrobial effect of the metal can be attributed either to the metal atoms themselves or preferably to the metals present in ionic form.

It is preferred if the antimicrobial active ingredient is present in the form of particles. In this way, the active ingredient can be easily incorporated into the material of which the bag section of the piping bag consists. The preferred use of the active ingredient in the form of particles is useful particularly when using metal atoms or metal ions as antimicrobial active ingredient.

Furthermore, it is preferred if the antimicrobial active ingredient, in particular the metal or the metal ions, are provided in a matrix. It is also possible that the active ingredient is at least partially immobilized in a matrix material or carrier material. Upon incorporation in a solvent, in particular in water, the metal is then present in ionic form. As a result of the matrix, the active ingredient in each case is stabilized. The matrix with active ingredient can advantageously be provided as a particulate material.

In the case of the two last-mentioned examples, it is further preferred if the average size of the particles of the active ingredient or the average size of the matrix particles (with active ingredient) is comparatively small. In this way, the largest possible overall surface area is provided, from which the antimicrobial active ingredient can develop its effect.

Accordingly, such average particle sizes, in particular average particle sizes of the matrix particles (matrix with active ingredient), are preferably less than about 10 μm, in particular less than about 5 μm. In these cases, the average particle size is advantageously between about 2 μm and about 5 μm. Smaller average particle sizes of less than about 1 μm may also be provided.

Suitable carrier material/matrix material includes, but is not limited to, for example, plastics, in particular thermoplastics. Preferably, glass may also be used as carrier material such that the antimicrobial active ingredient is present in a glass matrix. In all of the last-mentioned cases, it is also said that the active ingredient is present in a “solidified melt.”

The content of the active ingredient in the matrix, in particular the content of the metal or of the metal ions in the matrix, is generally less than about 10 000 ppm (parts per million), i.e., less than 1%. Preference is given to contents of less than about 5000 ppm, in particular of less than about 3000 ppm. In turn, contents between about 1000 ppm and about 2000 ppm, in particular between about 1500 ppm and about 1700 ppm, are advantageous.

For the preferred provision of the antimicrobial effect, in principle atoms or ions of different metals such as copper and also zinc are suitable. In particular, silver atoms or silver ions are used as antimicrobial active ingredient. Silver not only has an adequately high antimicrobial effect, but is moreover nontoxic to humans in the stated concentrations.

Preferably, the bag section consists of a natural or synthetic material, preferably of a fabric or cloth. The use of a cotton fabric or cotton cloth is further preferred. This flat structure is provided on both sides with at least one coating made of plastic. The plastic gives the bag section and thus the piping bag the tightness necessary for its use.

The use of a plastic-coated fabric enables the antimicrobial active ingredient to preferably be incorporated into the plastic coating and accordingly to be present in distributed form within the plastic. Thus, the antimicrobial active ingredient can develop its effect out of the plastic on the surface of the plastic coating.

In this connection, it is further preferred if the antimicrobial active ingredient is present in at least one coating which faces the inside of the piping bag. In this way, the antimicrobial active ingredient can exert its effect on the surfaces which come into contact with the corresponding foods that are introduced into the interior of the piping bag.

In the last-mentioned example, it is further preferred if all coatings which face the inside of the piping bag have the antimicrobial active ingredient. In this way, the antimicrobial effect which the piping bag has can be made more long-lasting.

In agreement with the previous examples, a comparatively simple variant of the piping bag can accordingly have an outer coating (which faces away from the inside of the piping bag) and an inner coating (which faces the inside of the piping bag). In such a variant, only the inner coating will then generally have the antimicrobial active ingredient, in particular, with the silver ions.

In a more sophisticated variant of the piping bag, one outer coating and a plurality of inner coatings, preferably two inner coatings, are provided. In this connection, at least the inner coating which comes into direct contact with the food then has the antimicrobial active ingredient, in particular the silver ions. In some circumstances, however, it is also possible for a plurality of inner coatings, for example, all two inner coatings of a variant with two inner coatings, to have the active ingredient.

For the plastic coatings, it is possible, as already indicated, to use highly diverse plastics which are suitable for such coatings from the point of view of processing technology and for providing the required tightness. These are preferably commercially available polyurethanes, the properties of which are known to those skilled in the art. These are generally provided for the coating in liquid-dissolved form, in which case the antimicrobial active ingredient, in particular the silver ions (optionally in a matrix), are then mixed into the plastic.

The amount of antimicrobial active ingredient introduced into the piping bag or into the corresponding coatings of the bag section is not critical. Generally, attempts should be made to employ the lowest possible amounts of antimicrobial active ingredient. This is first because active ingredients of this type are comparatively expensive. Second, the antimicrobial effect no longer increases significantly above a certain amount. This is also the case particularly if the antimicrobial active ingredient such as silver ions are added to a matrix or, in the case of a corresponding variant of the piping bag, if the active ingredient is incorporated into a plurality of plastic layers or coatings.

Accordingly, an additive of a matrix with the antimicrobial active ingredient, in particular silver, in the piping bag itself is present in particular in the corresponding coatings of the bag section (in total) in an amount of at least about 0.05% by weight. Amounts between about 0.1% by weight to about 5.0% by weight, in particular between about 0.3% by weight and about 2.0% by weight, are further preferred.

Finally, we also provide plastic-coated fabric intended for producing the piping bags. This fabric is moreover suitable in very general terms for use in the food industry and food sector.

In particular, the areas of bakeries, butchers and catering should be emphasized. The fabric can be used, as well as for producing piping bags, e.g., for producing works clothing of all types, aprons, gloves, covers for work surfaces and many more. The plastic-coated fabric is in this connection is characterized in that the plastic coating comprises at least partially at least one antimicrobial active ingredient.

As regards the antimicrobial active ingredient and the manner in which this is present in the plastic coating and/or in the fabric, reference is made to the statements hitherto in their entirety. The corresponding disclosure in connection with the piping bag should expressly also be regarded as disclosure for the plastic-coated fabric.

Preferably, the plastic-coated fabric is in the form of rolled material so that, for its use, it can be cut into lengths from the rolled material in an appropriate manner and cut out.

Our fabrics and piping bags described above are associated with a whole series of advantages. Thus, a plastic-coated fabric or a piping bag produced therefrom is provided which meets the required hygiene requirements with considerably lower cleaning expenditure. The user, in particular the user of the piping bag, can be sure, following customary cleaning after use, that the number of germs on the material has been adequately reduced. Consequently, for example, the piping bag can also be used over a longer period than was hitherto the case for piping bags without antimicrobial addition. Furthermore, odor formation for a piping bag which has been used several times is also considerably reduced. This gives the user additional assurance that the piping bag can also still be used in the future. Finally, the novel piping bag also gives its user the opportunity to once again stress to its customers the importance of hygienic conditions when working with foods.

The described and further features of our fabrics and piping bags arise from the example below. The individual features can be realized by themselves or in combination with one another.

### EXAMPLE

To produce a piping bag, first a cotton fabric is provided as is customary for the production of such piping bags. Then, to remove production auxiliaries from the fabric manufacture and to adjust the whiteness, this cotton fabric can then first be subjected to a bleaching process. The so-called “whiteness” is a measure of the white impression perceived visually.

Furthermore, a polyurethane mass is provided. This polyurethane mass is used to produce a coating on a side of the cotton fabric which is later to form the outer surface of the piping bag.

Into another part of the polyurethane mass is introduced a glass matrix with silver ions in an amount of 1.0% by weight. The fraction of silver ions in the glass matrix is 1700 ppm. The glass matrix is provided in the form of particles with an average particle size between 2 μm and 5 μm. The modified polyurethane mass obtained is then used to apply two (inner) coatings to the other side of the cotton fabric. This results in a polyurethane-coated fabric with one (outer) coating and two (inner) coatings. Both inner coatings comprise silver ions as antimicrobial active ingredient.

Piping bags are then produced in the usual way from the material thus obtained (plastic-coated fabric). For this purpose, the corresponding sections made of the material are bonded or fused with the help of a polyurethane adhesive to result in the corresponding frustoconical bag sections. These may be imprinted on the side which forms the outside of the bag (polyurethane without silver ions).

The fabric produced according to this example and the piping bags produced therefrom exhibit first in a test with the bacteria Staphylococcus aureus a very considerable reduction in germs of more than 99%. Moreover, odor formation in the case of samples which have been brought into contact with a food and which have then been cleaned in a standard domestic manner is significantly reduced.

Although the structures and methods have been described in connection with specific forms thereof, it will be appreciated that a wide variety of equivalents may be substituted for the specified elements described herein without departing from the spirit and scope of this disclosure as described in the appended claims.

1. A piping bag for applying pasty or creamy foods comprising an essentially frustoconical bag section comprising at least one antimicrobial active ingredient.

2. The piping bag according to claim 1, wherein that the antimicrobial active ingredient is metal atoms or metal ions.

3. The piping bag according to claim 1, wherein the antimicrobial active ingredient is in the form of particles.

4. The piping bag according to claim 1, wherein the antimicrobial active ingredient is provided in a matrix.

5. The piping bag according to claim 3, wherein the average particle size of the active ingredient or the average particle size of the matrix is less than about 10 μm.

6. The piping bag according to claim 1, wherein the antimicrobial active ingredient is silver atoms or ions.

7. The piping bag according to claim 1, wherein the bag section consists of a fabric provided on both sides with at least one plastic coating.

8. The piping bag according to claim 7, wherein the at least one antimicrobial active ingredient is present in at least one of the coatings.

9. The piping bag according to claim 8, wherein the antimicrobial active ingredient is present in at least one coating which faces the inside of the piping bag.

10. The piping bag according to claim 9, wherein the antimicrobial active ingredient is present in all coatings which face the inside of the piping bag.

11. The piping bag according to claim 7, wherein the bag section has two inner coatings which face the inside of the piping bag, and an outer coating which faces away from the inside of the piping bag.

12. The piping bag according to claim 7, wherein the plastic coating comprises a polyurethane.

13. The piping bag according to claim 1, wherein the antimicrobial active ingredient or an additive of matrix with active ingredient is present in the piping bag in an amount of at least about 0.05% by weight.

14. The piping bag according to claim 4, wherein the antimicrobial active ingredient is in the form of particles.

15. The piping bag according to claim 4, wherein the matrix is a glass matrix.

16. The piping bag according to claim 5, wherein the average particle size is less than about 5 μm.

17. The piping bag according to claim 7, wherein the fabric is cotton fabric.

18. The piping bag according to claim 4, wherein the average particle size of the active ingredient or the average particle size of the matrix is less than about 10 μm.

19. Fabric for use with pasty or creamy foods comprising a base cloth and a plastic coating on the base cloth comprising at least one antimicrobial active ingredient.

20. The fabric according to claim 19, provided in rolled material form.
